(19) United States
(12) Patent Application Publication
(10) Pub. No.: US 2020/0381979 A1
(43) Pub. Date: Dec. 3, 2020

(54) BLOWER AND VACUUM CLEANER

(71) Applicant: Nidec Corporation, Kyoto (JP)

(72) Inventor: Ryosuke HAYAMITSU, Kyoto (JP)

(21) Appl. No.: 16/884,272

(22) Filed: May 27, 2020

(30) Foreign Application Priority Data
May 29, 2019 (JP) 2019-100583

(51) Int. Cl. H02K 7/14; A47L 5/14; H02K 3/34

(52) U.S. Cl. CPC H02K 7/14; H02K 1/2733; H02K 3/345; A47L 5/14

(57) ABSTRACT

A blower includes a rotor, a stator, an impeller, and a housing. The stator includes a stator core including an umbrella portion radially outward of the magnet, a first core portion radially outward of the umbrella portion and extending in a first direction orthogonal or substantially orthogonal to the radial direction, and a second core portion connecting the umbrella portion to the first core portion, an insulator at least partly covering the first core portion, and a coil defined by a conductive wire wound around the first core portion with the insulator interposed between the conductive wire and the first core portion. The housing includes a first region radially outward of the coil. The first region includes a radially inner surface that is radially opposed to a radially outer surface of the coil.

### CROSS REFERENCE TO RELATED APPLICATION

The present application claims priority under 35 U.S.C. § 119 to Japanese Application No. 2019-100583 filed on May 29, 2019 the entire contents of which is hereby incorporated by reference.

### 1. FIELD OF THE INVENTION

The present disclosure relates to a blower and a vacuum cleaner.

### 2. BACKGROUND

A conventional blower includes a stator unit having a stator coil, accommodated in a case body, a centrifugal fan fixed to an end of a rotor shaft passing through a bearing mounting portion, and a fan cover attached to an opening at one end of the case body, covering the centrifugal fan and a case end plate, and the stator coil and an electric unit are covered with a resin mold.

The above configuration enables reduction in the number of components to be assembled and improvement in assembling work while maintaining dust-proof and waterproof effects, and also enables improvement in cooling efficiency and blowing efficiency.

The conventional blower, however, is less likely to cool a coil while reducing decreases in blowing efficiency with a simple structure.

### SUMMARY

A blower according to an example embodiment of the present disclosure includes a rotor that includes a shaft extending along a central axis extending vertically and that includes a magnet fixed to the shaft, a stator that is opposed to the rotor in a radial direction, an impeller that is fixed to the shaft and that is rotatable about the central axis, and a housing that is at least partly radially outward of a radially outer end of the impeller. The stator includes a stator core including an umbrella portion that is located radially outward of the magnet, a first core portion that is located radially outward of the umbrella portion and that extends in a first direction orthogonal or substantially orthogonal to the radial direction, and a second core portion connecting the umbrella portion to the first core portion, an insulator at least partly covering the first core portion, and a coil defined by a conductive wire wound around the first core portion with the insulator interposed between the conductive wire and the first core portion. The housing includes a first region located radially outward of the coil. The first region includes a radially inner surface that is radially opposed to a radially outer surface of the coil.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a vacuum cleaner according to an example embodiment of the present disclosure.

FIG. 2 is a perspective view of a blower according to an example embodiment of the present disclosure.

FIG. 3 is a longitudinal sectional view of a blower according to an example embodiment of the present disclosure.

FIG. 4 is a cross-sectional view of a blower according to an example embodiment of the present disclosure.

FIG. 5 is a perspective view of a first housing according to an example embodiment of the present disclosure when viewed from above.

FIG. 6 is a perspective view of a first housing according to an example embodiment of the present disclosure when viewed from below.

FIG. 7 is a perspective view of a second housing according to an example embodiment of the present disclosure when viewed from above.

FIG. 8 is a perspective view of a second housing according to an example embodiment of the present disclosure when viewed from below.

### DETAILED DESCRIPTION

Hereinafter, example embodiments of the present disclosure will be described with reference to the drawings. In the present specification, a direction in which a central axis J of a blower 100 extends is referred to as a “vertical direction”, “vertical”, or “vertically”, or an “axial direction”, “axial”, or “axially”, a direction orthogonal to the central axis J of the blower 100 is referred to as a “radial direction”, “radial”, or “radially”, and a direction along an arc about the central axis J of the blower 100 is referred to as a “circumferential direction”, “circumferential”, or “circumferentially”. However, the above “vertical direction” does not limit a direction of the blower 100 when it is actually incorporated into an apparatus. The drawings each may describe a content different from an actual structure for convenience. In the drawings, hatching may be eliminated for convenience. In the present specification, the terms such as the vertical direction, the axial direction, the radial direction, and the circumferential direction include not only those directions strictly indicated, but also directions slightly deviating from those directions.

The present specification will describe a shape and a positional relationship of each part of a vacuum cleaner A with a direction approaching a floor F, indicated as “downward”, and a direction away from the floor F, indicated as “upward”. These directions are simply names used for description, and do not limit actual positional relationships and directions. In addition, “upstream” and “downstream” respectively indicate upstream and downstream in a flow direction of gas sucked from an intake portion 103 when the blower 100 is driven.

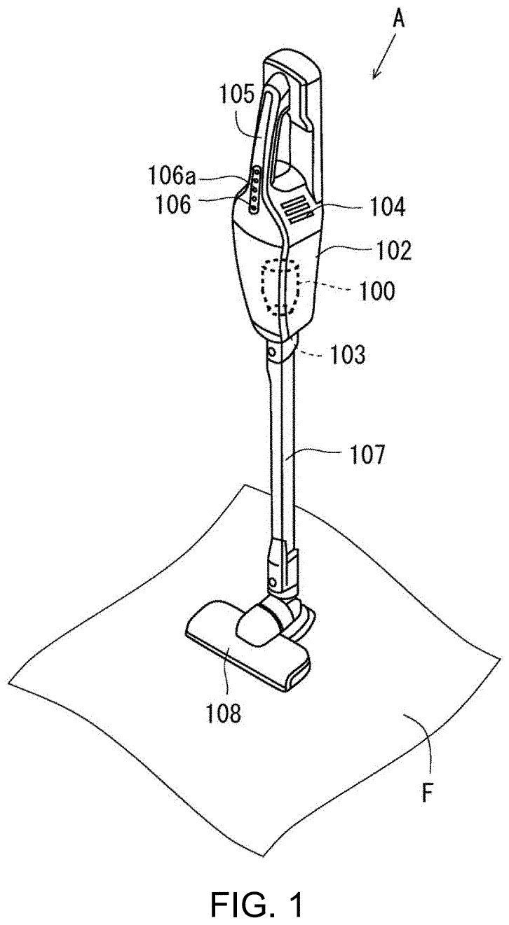

A vacuum cleaner A according to an exemplary example embodiment of the present disclosure will be described. FIG. 1 is a perspective view of the vacuum cleaner A according to the example embodiment of the present disclosure. The vacuum cleaner A is a so-called stick-type vacuum cleaner, and includes a housing 102 having a lower surface and an upper surface that are provided with an intake portion 103 and an exhaust portion 104, respectively. The housing 102 has a rear surface through which a power cord (not illustrated) is led out. The power cord is connected to a power outlet (not illustrated) provided on a side wall surface of a living room, and is used to supply electric power to the vacuum cleaner A. The vacuum cleaner A may be an electric vacuum cleaner of a so-called robot type, canister type, or handy type.

The housing 102 is provided inside with an air passage (not illustrated) that connects the intake portion 103 and the exhaust portion 104. In the air passage, a dust collector (not illustrated), a filter (not illustrated), and the blower 100 are sequentially disposed from an upstream side to a downstream side. The blower 100 includes an impeller 30 described later. The filter blocks foreign matters such as dust contained in gas flowing through the gas passage, and the foreign matters are collected in the dust collector formed in the shape of a container. The dust collector and the filter are configured to be detachable from the housing 102.

The housing 102 is provided above with a grip portion 105 and an operation portion 106. A user can move the vacuum cleaner A while holding the grip portion 105. The operation portion 106 includes a plurality of buttons 106a, and operation of the vacuum cleaner A is set by operating the buttons 106a. For example, the buttons 106a are operated to instruct the blower 100 to start driving, stop driving, change its rotation speed, and the like. The intake portion 103 is connected to a downstream end (an upper end in the drawing) of a suction pipe 107 in the shape of a rod. The suction pipe 107 has an upstream end to which a suction nozzle 108 is attached in a detachable manner to the suction pipe 107. Foreign matters on the floor F is sucked into the suction pipe 107 through the suction nozzle 108.

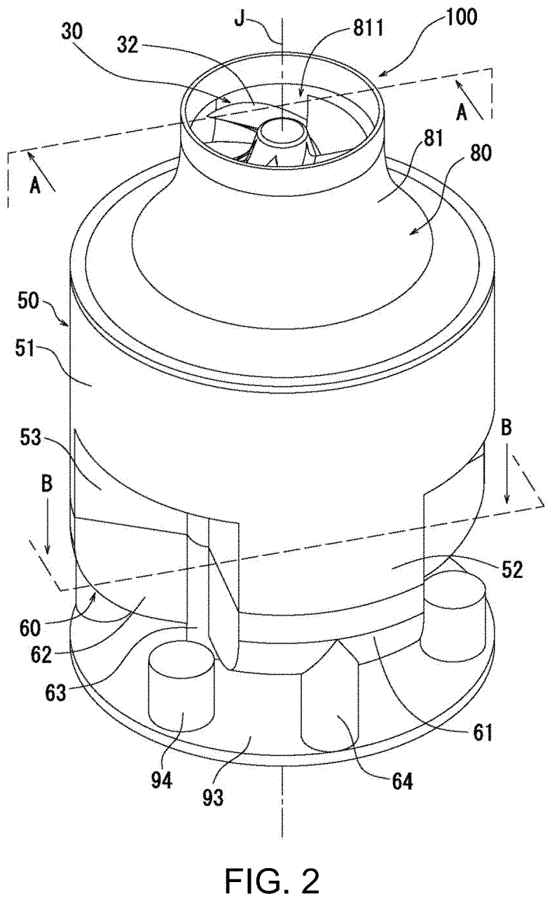

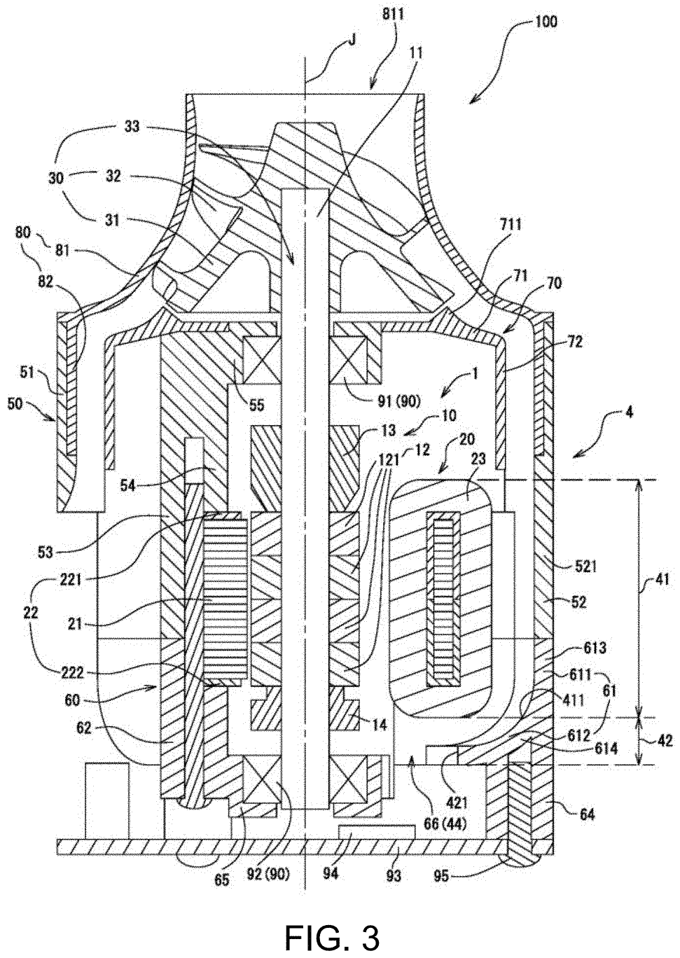

FIG. 2 is a perspective view of the blower 100. FIG. 3 is a longitudinal sectional view of the blower 100. More specifically, FIG. 3 is a cross-sectional view of the blower 100 taken along virtual plane A-A in FIG. 2. Referring to FIGS. 2 and 3, the blower 100 includes a motor 1 and the impeller 30 that is driven and rotated by the motor 1. More specifically, the blower 100 includes a rotor 10, a stator 20, the impeller 30, and a housing 4.

The motor 1 includes the rotor 10 and the stator 20. The rotor 10 includes a shaft 11 and a magnet 12. More specifically, the rotor 10 includes the shaft 11 disposed along the central axis J extending vertically. The shaft 11 is supported by a bearing 90 described later in a rotatable manner to the stator 20. In the present example embodiment, the bearing 90 includes an upper bearing 91 and a lower bearing 92. The magnet 12 is fixed to the shaft 11. The magnet 12 includes a plurality of annular magnet pieces 121 aligned in the axial direction. An upper spacer 13 is disposed above the magnet 12, and a lower spacer 14 is disposed below the magnet 12. The magnet 12 has an upper surface in contact with a lower surface of the upper spacer 13, and a lower surface in contact with an upper surface of the lower spacer 14. In the present example embodiment, the magnet 12 is fixed to a radially outer surface of the shaft 11 with an adhesive. Alternatively, the magnet 12 may be fixed to the shaft 11 by another means, or may be indirectly fixed to the shaft 11 with another member interposed therebetween.

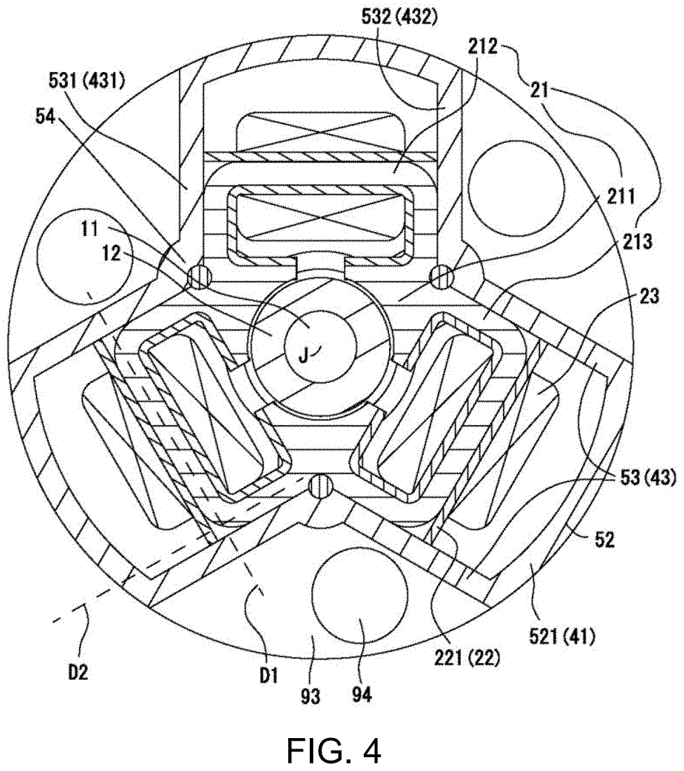

FIG. 4 is a cross-sectional view of the blower according to the example embodiment of the present disclosure. More specifically, FIG. 4 is a cross-sectional view of the blower 100 taken along virtual plane B-B in FIG. 2. Referring to FIGS. 3 and 4, the stator 20 is disposed facing the rotor 10 in the radial direction. The stator 20 includes a stator core 21, an insulator 22, and a coil 23.

The stator core 21 includes an umbrella portion 211, a first core portion 212, and a second core portion 213. The umbrella portion 211 is disposed radially outward of the magnet 12. The first core portion 212 is disposed radially outward of the umbrella portion 211. The first core portion 212 extends in a first direction D1 substantially orthogonal to the radial direction. In the present example embodiment, the radial direction connecting the center of the first core portion 212 in the first direction D1 and the central axis J is substantially orthogonal to the first direction D1. The second core portion 213 connects the umbrella portion 211 and the first core portion 212. In the present example embodiment, the second core portion 213 extends in a second direction D2 substantially orthogonal to the first direction D1.

The first core portion 212 is at least partly covered with the insulator 22. In the present example embodiment, the insulator 22 includes an upper insulator 221 and a lower insulator 222. The upper insulator 221 is disposed covering at least partly an upper surface of the stator core 21. The lower insulator 222 is disposed covering at least partly a lower surface of the stator core 21. The insulator 22 may be composed of a single member, or may be composed of three or more members.

The coil 23 is formed by winding a conductive wire around the first core portion 212 with the insulator 22 interposed therebetween. The conductive wire is electrically connected at one end to a base plate 93 described later. In the present example embodiment, the conductive wire is electrically connected at one end to a terminal (not illustrated), and the terminal is electrically connected to the base plate 93. As illustrated in FIG. 4, in plan view, the coil 23 has a length in the first direction D1 that is longer than a length in the second direction D2. The length of the coil 23 in the first direction D1 is more than a diameter of the magnet 12. This enables increase in output of the motor 1 while preventing the motor 1 from increasing in radial length. The coil 23 is a so-called toroidal coil.

Referring to FIGS. 2 and 3, the impeller 30 includes a hub 31, a plurality of blades 32, and an impeller recessed portion 33. The hub 31 extends radially outward and downward from its radially central portion. The plurality of blades 32 is disposed on an upper surface of the hub 31 at equal intervals in the circumferential direction. The impeller recessed portion 33 is recessed upward at the radially central portion of the hub 31. The shaft 11 is fixed to the impeller recessed portion 33 with an adhesive. That is, the impeller 30 is fixed to the shaft 11, and is rotatable about the central axis J. The impeller 30 may include a main plate extending in a direction orthogonal to the central axis J and a plurality of blades disposed on an upper surface of the main plate. The impeller 30 and the shaft 11 may be fixed by another means or structure.

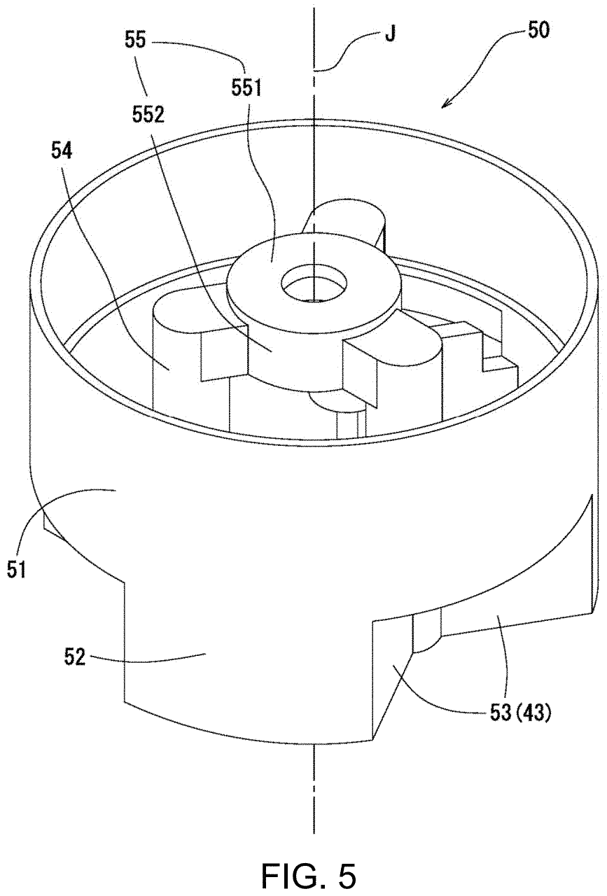

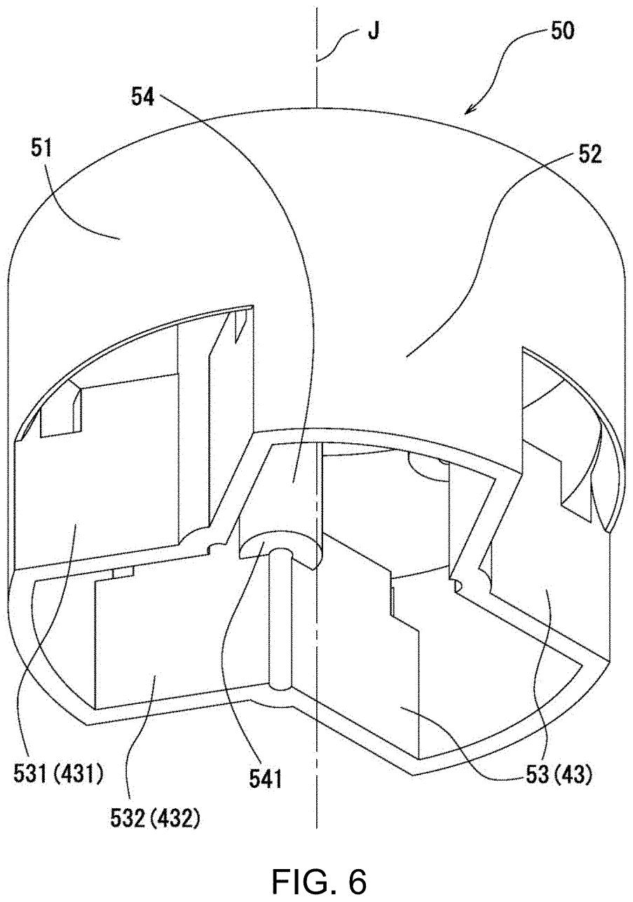

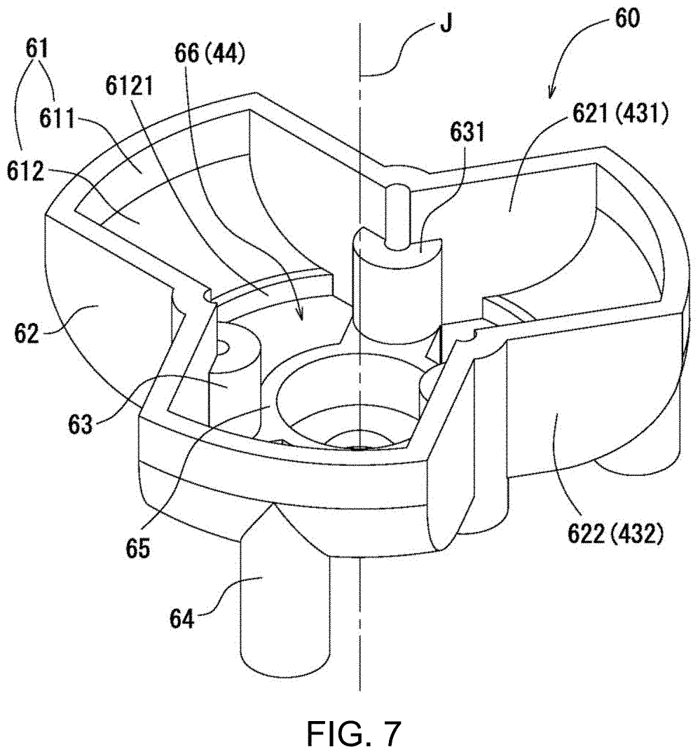

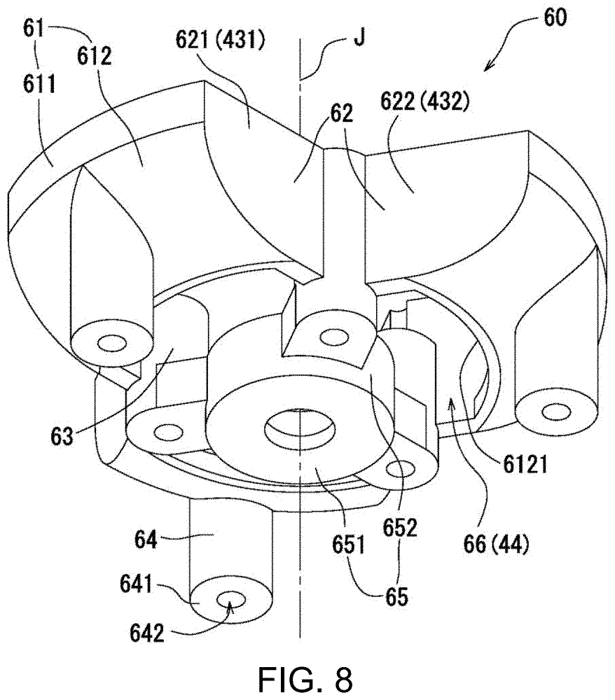

Referring to FIG. 3, the housing 4 includes a first housing 50, a second housing 60, a third housing 70, and a fourth housing 80. FIG. 5 is a perspective view of the first housing 50 according to the example embodiment of the present disclosure when viewed from above. FIG. 6 is a perspective view of the first housing 50 according to the exemplary example embodiment of the present disclosure when viewed from below. FIG. 7 is a perspective view of the second housing 60 according to the example embodiment of the present disclosure when viewed from above. FIG. 8 is a perspective view of the second housing 60 according to the example embodiment of the present disclosure when viewed from below. The housing 4 may be composed of five or more members, or may be composed of three or less members.

The first housing 50 is a part of the housing 4. The housing 4 is at least partly disposed radially outward of a radially outer end of the impeller 30. Referring to FIGS. 3 to 6, the first housing 50 includes an outer tubular portion 51, an outer wall portion 52, and an inner wall portion 53. The outer tubular portion 51 extends in the axial direction to form a tubular shape. The outer wall portion 52 extends downward from a lower portion of the outer tubular portion 51. In the present example embodiment, the outer wall portion 52 extends downward from the lower portion of the outer tubular portion 51 to constitute a part of a cylinder in the circumferential direction. The outer wall portion 52 is one of outer wall portions 52 disposed at respective three locations at equal intervals in the circumferential direction.

The inner wall portion 53 is one of inner wall portions 53 extending from opposite circumferential ends of the corresponding outer wall portions 52 in a direction approaching the central axis J to form the shape of a wall. In the present example embodiment, the inner wall portions 53 extend in the direction approaching the central axis J from respective portions facing each other in the circumferential direction of the corresponding outer wall portions 52 adjacent to each other in the circumferential direction, and the two inner wall portions 53 adjacent to each other have radially inner ends connected to each other.

In a region where the inner wall portions 53 adjacent to each other in the circumferential direction are connected, a protrusion 54 is formed. The protrusion 54 extends upward from the radially inner ends of the corresponding inner wall portions 53. In the present example embodiment, the protrusion 54 extends in the axial direction to form a columnar shape. The protrusion 54 has a lower surface 541 in contact with an upper surface of the upper insulator 221. The lower surface 541 of the protrusion 54 is formed with a recessed portion recessed upward, and the stator 20 and the first housing 50 are fixed to each other by inserting a fixing member into the recessed portion. The stator 20 and the first housing 50 may be fixed by another means. For example, the first housing 50 may be at least partly fixed to the stator core 21.

The protrusion 54 is connected at its upper end to a bearing holder 55. The bearing holder 55 includes a top surface portion 551 having a through hole and extending in a direction orthogonal to the axial direction, and a tubular portion 552 extending downward from a radially outer edge of the top surface portion 551. The tubular portion 552 has a radially inner surface to which the upper bearing 91 is fixed.

The second housing 60 is a part of the housing 4. Referring to FIGS. 3, 7, and 8, the second housing 60 includes an outer wall portion 61 and an inner wall portion 62. The outer wall portion 61 is connected to a lower end of the outer wall portion 52 of the first housing 50 and extends downward. In the present example embodiment, the outer wall portion 61 includes a wall portion 611 that is connected to a lower end of the outer wall portion 52 of the first housing 50 and that extends substantially in the axial direction, and a curved surface portion 612 that extends downward from a lower end of the wall portion 611 while extending in a direction approaching the central axis J. The outer wall portion 61 is one of outer wall portions 61 disposed at respective three locations at equal intervals in the circumferential direction.

The inner wall portion 62 is connected to a lower end of the inner wall portion 53 of the first housing 50 and extends downward. The inner wall portion 62 is one of inner wall portions 62 extending from opposite circumferential ends of the corresponding outer wall portions 61 in a direction approaching the central axis J to form the shape of a wall. In the present example embodiment, the inner wall portions 62 extend in a direction approaching the central axis J from portions of the corresponding outer wall portions 61 adjacent to each other in the circumferential direction, the portions facing each other in the circumferential direction. The inner wall portions 62 at two locations have respective radially inner ends that are connected to each other.

In a region where the inner wall portions 62 adjacent to each other in the circumferential direction are connected, a first protrusion 63 is formed. The first protrusion 63 extends downward from the radially inner ends of the corresponding inner wall portions 62. In the present example embodiment, the first protrusion 63 extends in the axial direction to form a columnar shape. The first protrusion 63 has an upper surface 631 in contact with an lower surface of the lower insulator 222. The first protrusion 63 is formed with a through hole passing through the first protrusion 63 in the axial direction, and the stator 20 and the second housing 60 are fixed by inserting a fixing member into the through hole. The stator 20 and the second housing 60 may be fixed by another means. For example, the second housing 60 may be at least partly fixed to the stator core 21.

The outer wall portion 61 is provided on its lower surface with a second protrusion 64. More specifically, the second protrusion 64 extends downward from a lower surface of the curved surface portion 612. The second protrusion 64 has a lower surface 641 formed with a recessed portion 642 that is recessed upward.

The first protrusion 63 is connected at its lower end to a bearing holder 65. The bearing holder 65 includes a bottom surface portion 651 having a through hole and extending in a direction orthogonal to the axial direction, and a tubular portion 652 extending upward from a radially outer edge of the bottom surface portion 651. The tubular portion 652 has a radially inner surface to which the upper bearing 92 is fixed.

The second housing 60 includes a through hole 66 passing therethrough in the axial direction. The through hole 66 in the second housing 60 corresponds to a through hole 44 in the housing 4. The through hole 66 is formed between a radially inner end 6121 of the curved surface portion 612 and the tubular portion 652 in the radial direction. In the present example embodiment, three through holes 66 are formed at equal intervals in the circumferential direction.

In the present example embodiment, three outer wall portions 52 and three outer wall portions 61 are disposed in the circumferential direction. The coil 23 is disposed radially inward of the outer wall portion 52. The coil 23 is disposed radially inward of the outer wall portion 61. That is, the outer wall portion 52 and the inner wall portion 53, and the outer wall portion 61 and the inner wall portion 62, form a flow path extending in the axial direction, and the coil 23 is disposed in the flow path.

The third housing 70 is a part of the housing 4. Referring to FIG. 3, the third housing 70 includes a top surface portion 71 and a tubular portion 72. The top surface portion 71 extends in a direction substantially orthogonal to the axial direction. The top surface portion 71 is at least partly fixed to the first housing 50. The tubular portion 72 extends downward from a radially outer edge of the top surface portion 71 to form a tubular shape.

The top surface portion 71 has an upper surface formed with a protrusion 711 in an annular shape protruding upward. The top surface portion 71 has a region that extends from the protrusion 711 toward its radially outer edge and that is smoothly continuous with the upper surface of the hub 31. This enables gas discharged by the impeller 30 to be smoothly guided radially outward and downward.

The fourth housing 80 is a part of the housing 4. Referring to FIGS. 2 and 3, the fourth housing 80 includes a projecting portion 81 and a tubular portion 82. The projecting portion 81 extends radially inward and upward from outside the radially outer end of the impeller 30. In the present example embodiment, the projecting portion 81 is in a tubular shape decreasing in diameter upward. The projecting portion 81 has a radially inner surface facing a radially outer end of the blade 32 with a gap therebetween. The projecting portion 81 is provided in its radially central portion with an intake port 811 passing through the projecting portion 81 in the axial direction. Thus, when the impeller 30 is rotated, gas above the intake port 811 is sucked into the blower 100 through the intake port 811 and is discharged downward by the impeller 30.

The tubular portion 82 extends downward from a radially outer end of the projecting portion 81 to form a tubular shape. The tubular portion 82 is fixed to the outer tubular portion 51. In the present example embodiment, the tubular portion 82 has a radially outer surface that is in contact with a radially inner surface of the outer tubular portion 51. The tubular portion 72 has a radially outer surface that faces a radially inner surface of the tubular portion 82 in the radial direction with a gap therebetween to form a flow path. This causes gas discharged from the impeller 30 to first flow downward in the flow path formed radially between the radially outer surface of the tubular portion 72 and the radially inner surface of the tubular portion 82. Next, some of the gas discharged downward from the flow path passes through a space radially inward of the outer wall portion 52 and the outer wall portion 61, and is discharged downward through the through hole 66. Another gas flows downward in a circumferential space between the outer wall portion 52 and the outer wall portion 62 adjacent to each other in the circumferential direction, and hits against the base plate 93 described later. The tubular portion 82 has a radially inner surface that is smoothly continuous with a radially inner surface of the outer tubular portion 51. This allows the gas flowing downward in a space radially inward of the tubular portion 82 to smoothly flow downward in a space radially inward of the outer tubular portion 51 and the outer wall portion 52, so that the blower 100 can be prevented from decreasing in blowing efficiency.

The coil 23 has a radially outer surface disposed radially inward of the radially outer surface of the tubular portion 72. This allows the gas having flowed downward in a space radially outward of the tubular portion 72 to flow smoothly downward in a space radially outward of the coil 23. Thus, compared with when some of the gas hits against an upper surface of the coil 23, the blower 100 can be prevented from decreasing in blowing efficiency.

Referring to FIGS. 2 and 3, the base plate 93 is disposed below the second housing 60. The base plate 93 is a plate-like member extending in a direction orthogonal to the axial direction. On the base plate 93, a plurality of elements 94 is disposed. The base plate 93 has an upper surface that is at least partly in contact with the lower surface 641 of the second protrusion 64. The base plate 93 and the second housing 60 are fixed to each other by fixing a fixing member 95 to the recessed portion 642 through a through hole of the base plate 93.

Referring to FIGS. 2 to 8, the housing 4 has a first region 41 disposed radially outward of the coil 23. The first region 41 has a radially inner surface that is radially opposed to a radially outer surface of the coil 23. This enables a flow path to be formed radially outward of the coil 23 by the first region 41, so that gas discharged by the impeller 30 can flow along the first region 41. This enable the gas to flow near the radially outer surface of the coil 23, so that the coil 23 can be efficiently cooled.

In the present example embodiment, the first region 41 extends over a part of the outer wall portion 52 of the first housing 50 and a part of the outer wall portion 61 of the second housing 60. That is, the outer wall portion 52 has a first region 521. Then, the outer wall portion 61 has a first region 613. In other words, the first region 521 of the outer wall portion 52 of the first housing 50 and the first region 613 of the outer wall portion 61 of the second housing 60 constitute the first region 41 of the housing 4.

The housing 4 has a second region 42 disposed below the first region 41. The second region 42 extends downward from a lower end of the first region 41. In the present example embodiment, the second housing 60 has a second region 614. The second region 614 in the second housing 60 corresponds to the second region 42 in the housing 4. The second region 42 has a radially inner end 421 that is disposed radially inward of a radially inner end 411 of the first region 41. This enables gas flowing in a space radially inward of the first region 41 to be guided in a direction approaching the central axis J. Thus, the gas can be guided below the coil 23, the coil 23 can be efficiently cooled. At least a part of the first housing 50 may have the second region 42.

The second region 42 has a radially inner surface that extends radially inward as extending downward. This enables gas flowing in a space radially inward of the second region 42 to be efficiently guided to the vicinity of the coil 23, so that the coil 23 can be efficiently cooled. In the present example embodiment, the radially inner surface of the second region 42 is a curved surface that extends radially inward as extending downward, and that is convex downward and radially outward. This enables the gas flowing in the space radially inward of the second region 42 to be smoothly guided downward and radially inward. Thus, the coil 23 can be efficiently cooled while the blower 100 is prevented from decreasing in blowing efficiency. The radially inner surface of the second region 42 may be a flat surface extending radially inward as extending downward.

The radially inner end 421 of the second region 42 is disposed below a lower end of the coil 23 and radially inward of a radially outer end of the coil 23. That is, the radially inner surface of the second region 42 is formed along a curved surface drawn from the radially outer surface of the coil 23 to a lower surface thereof. This enables gas flowing in the space radially inward of the first region 41 to flow below the coil 23 from the space radially outward of the coil 23. Thus, the coil 23 can be efficiently cooled while the blower 100 is prevented from decreasing in blowing efficiency.

The housing 4 further has a third region 43. The third region 43 has a third-region one side 431 and a third-region other side 432. The third-region one side 431 extends in a direction approaching the central axis J from the first region 41 on one side in the first direction D1 of one end of the coil 23 in the first direction D1. In the present example embodiment, the inner wall portions 53, 62 disposed on one side in the first direction D1 with respect to the coil 23 correspond to the third-region one side 431. The third-region other side 432 extends in a direction approaching the central axis J from the first region 41 on the other side in the first direction D1, outward of the other end of the coil 23 in the first direction D1. In the present example embodiment, the inner wall portions 53, 62 disposed on the other side in the first direction D1 with respect to the coil 23 correspond to the third-region other side 432.

More specifically, a third-region one side 531 in the first housing 50 and a third-region one side 621 in the second housing 60 correspond to the third-region one side 431. In addition, a third-region other side 532 in the first housing 50 and a third-region other side 622 in the second housing 60 correspond to the third-region other side 432. The third region 43 may be disposed in only one of the first housing 50 and the second housing 60. Further, the third region 43 may be disposed over three or more members.

That is, the housing 4 has the third region 43 that extends from the first region 41 in a direction approaching the central axis J on the one side in the first direction D1, outward of the one end of the coil 23 in the first direction D1. This enables gas flowing on one side in the first direction D1 with respect to the coil 23 to be prevented from spreading on the one side in the first direction D1. Thus, more gas flows near the coil 23, so that the coil 23 can be efficiently cooled. In particular, in the present example embodiment, one side in the first direction D1 coincides with a front side in a rotation direction of the impeller 30. Thus, when the third region 43 is provided, some of gas discharged by the impeller 30 flows toward one side in the first direction D1 with respect to the coil 23, and is prevented from flowing away from the coil 23 to enable the gas to flow downward along the third region 43. This enables the gas flowing on one side of the coil 23 in the first direction D1 to be increased in amount, so that the coil 23 can be cooled efficiently.

The third region 43 has a lower end disposed below the lower end of the coil 23. This enables one side surface of the coil 23 in the first direction D1 to the lower end of the coil 23 to be cooled. Thus, the coil 23 can be efficiently cooled. A distance between the coil 23 and the third region 43 in the first direction D1 is preferably substantially constant in the axial direction. This enables gas flowing near the coil 23 to be increased in amount over a region where the third region 43 extends in the axial direction, so that the coil 23 can be efficiently cooled.

The third region 43 is at least partly in contact with the second core portion 213 in the circumferential direction. This enables the second housing 60 and the stator core 21 to be positioned in the circumferential direction. In the present example embodiment, both the third-region one side 431 and the third-region other side 432 are in contact with the second core part 213 in the circumferential direction. Thus, the second housing 60 and the stator core 21 can be positioned more accurately in the circumferential direction.

The housing 4 includes the through hole 44 passing therethrough in the axial direction in a region radially inward of the second region 42. In the present example embodiment, the through hole 66 provided in the second housing 60 corresponds to the through hole 44. This enables gas flowing downward along the radially inner surface of the outer wall portion 61 to be smoothly guided below the second housing 60. This enables preventing generation of turbulence near the radially inner end 6121 of the outer tubular portion 51. In the present example embodiment, the base plate 93 is disposed below the second housing 60, so that gas flowing downward through the through holes 66 is guided to an upper surface of the base plate 93 to enable the base plate 93 to be efficiently cooled.

In the present example embodiment, at least one of the elements 94 is disposed below the through hole 66. That is, the blower 100 includes the base plate 93 that extends in a direction substantially orthogonal to the axial direction and that is provided on its upper surface with the plurality of elements 94. The at least one of the elements 94 is at least partly aligned with the through hole 66 in the axial direction. This enables the at least one of the elements 94 to be efficiently cooled by gas flowing downward through the through hole 66. When the elements 94 are each an FET, the cooling effect is particularly remarkable.

In the present example embodiment, the first region 41 is disposed over both the first housing 50 and the second housing 60. Alternatively, only the first housing 50 may have the first region 41, or only the second housing 60 may have the first region 41. In the present example embodiment, only the second housing 60 has the second region 42. Alternatively, the second region 42 may be disposed over both the first housing 50 and the second housing 60. In the present example embodiment, both the first housing 50 and the second housing 60 have the third region 43. Alternatively, only one of the first housing 50 and the second housing 60 may have the third region 43. That is, at least a part of the housing 4 composed of a single member or a plurality of members may have the first region 41, the second region 42, and the third region 43.

The vacuum cleaner A includes the above-described blower 100. This enables the vacuum cleaner A to cool the coil 23 with a simple structure while preventing the blower 100 from decreasing in blowing efficiency.

The present disclosure can be used for, for example, a blower for a vacuum cleaner.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A blower comprising:
a rotor that includes a shaft extending along a central axis extending vertically and that includes a magnet fixed to the shaft;
a stator that is opposed to the rotor in a radial direction;
an impeller that is fixed to the shaft and that is rotatable about the central axis; and
a housing that is at least partly radially outward of a radially outer end of the impeller; wherein
the stator includes:
a stator core including an umbrella portion that is located radially outward of the magnet, a first core portion that is located radially outward of the umbrella portion and that extends in a first direction orthogonal or substantially orthogonal to the radial direction, and a second core portion connecting the umbrella portion to the first core portion;
an insulator at least partly covering the first core portion; and
a coil defined by a conductive wire wound around the first core portion with the insulator interposed between the conductive wire and the first core portion;
the housing includes a first region located radially outward of the coil; and
the first region includes a radially inner surface that is radially opposed to a radially outer surface of the coil.

2. The blower according to claim 1, wherein
the housing includes a second region below the first region; and
the second region includes a radially inner end that is located radially inward from a radially inner end of the first region.

3. The blower according to claim 2, wherein the radially inner surface of the second region extends radially inward and downward.

4. The blower according to claim 2, wherein the radially inner end of the second region is located below a lower end of the coil and radially inward of a radially outer end of the coil.

5. The blower according to claim 1, wherein the housing includes a third region extending in a direction approaching the central axis from the first region on one side in the first direction of one end of the coil in the first direction.

6. The blower according to claim 5, wherein the third region includes a lower end below the lower end of the coil.

7. The blower according to claim 5, wherein the third region is at least partly in circumferential contact with the second core portion.

8. The blower according to claim 2, wherein the housing includes a through-hole passing through the housing axially in a region radially inward of the second region.

9. The blower according to claim 8, further comprising a base plate that extends in a direction orthogonal or substantially orthogonal to the axial direction and includes a plurality of elements on its upper surface; wherein
at least one of the elements is at least partly aligned with the through hole in the axial direction.

10. A vacuum cleaner comprising the blower according to claim 1.
